(19) United States
(12) Patent Application Publication
(10) Pub. No.: US 2002/0151320 A1
(43) Pub. Date: Oct. 17, 2002

(54) Wireless group communication system

(76) Inventor: Reidar Wasenius, Esbo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/828,149

(22) Filed: Apr. 9, 2001

(51) Int. Cl. H04B 5/00; H04B 7/00; H04Q 7/20

(52) U.S. Cl. 455/518; 455/519; 455/41

(57) ABSTRACT

A system for group interaction of mobile terminals. A group is established with one terminal acting as a master using the Bluetooth protocol or other wireless links. By working in a group, additional functionality is obtained since part of the functions, applications or software of the individual terminals is different, so that group interactions provide more powerful instruments.

### BACKGROUND OF THE INVENTION

1. Field of the Invention

The invention relates generally to a system involving a group of wireless terminals which interact and more particularly to a system for allowing a group of wireless terminals to share functions therebetween for increased functionality.

2. Description of the Background

Wireless terminals of various kinds have become very popular in recent years. This is especially true of cellular telephones which provide a very convenient manner of reaching people no matter where they are located and allowing cellular telephone owners freedom to make calls from whereever they are located. Other wireless devices have similarly become popular. These include, mobile phones, cordless phones, pagers, electronic notebooks, computers with integrated radios, wireless headsets, wireless printers, wireless keyboards, and other electronic equipment which utilize wireless radio links.

As much as possible, additional functions have been added to cellular telephones and other wireless devices to make them more useful and also more fun to use. In addition to basic communication needs, these devices now also allow users the possibility of playing games, accessing the Internet for information and for educational purposes. Thus, any additional function which can be added to these devices in order to make their use more fun, more educational and more useful is important.

It is possible for two or more wireless devices to interact among themselves using a short range radio link. One such protocol is known as Bluetooth which is publically available on the Internet at http://www.bluetooth.com. A further description of such a system is found in WO 00/69186 which shows a system utilizing the Blue tooth protocol.

As indicated in these Bluetooth publications, two or more wireless devices can communicate with each other by making one of the devices a master device which polls other devices in the area to form an active group. However, the system described in this publication only relates to the forming of the communication system and does not define any specific additional functionality to Bluetooth wireless connection specification of a group which is created in the various wireless devices after they form a group.

U.S. Pat. No. 4,820,167 shows an electronic school teaching system. Each student has a read and test unit in the form of a textbook memory module which is connected to a teachers' computer and an administrative computer in the main office. The students unit receives homework assignments and allows the student to review the assigned material and perform their homework or tests thereon. Tests can be graded and the results given to both the teacher and the administrator for recordation. Systems such as this are useful in helping the teacher instruct students in their lessons. However, it does not add any fun or additional functions to the wireless devices of the student.

U.S. patent application Ser. No. 09/609,581 filed on Jun. 30, 1999 and it's CIP Application 09/755,584 filed on Jan. 5, 2000 describe a network having mobile terminals with wireless access to the Internet. This system describes how terminals may become part of a group and how a gateway server provides management services. However, this system does not provide for additional functionality on the parts of the terminals or for students to have more fun in using their wireless devices.

### SUMMARY OF THE INVENTION

The present invention provides a system whereby a group of wireless terminals may interact.

The present invention also provides a system having a plurality of wireless terminals which may interact to provide additional functionality to the terminals.

The present invention also provides a system for wireless terminals to interact in order to provide additional educational, business and other group communication opportunities and additional entertainment for users.

The present invention further provides a method of wireless devices interacting to obtain additional functionality.

The present invention still further provides a wireless device having functions, which are variable from one device to another so that when devices interact, additional functions are provided to the group.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic representation of a group of wireless terminals according to the present invention;

### DESCRIPTION OF THE PREFERRED EMBODIMENTS

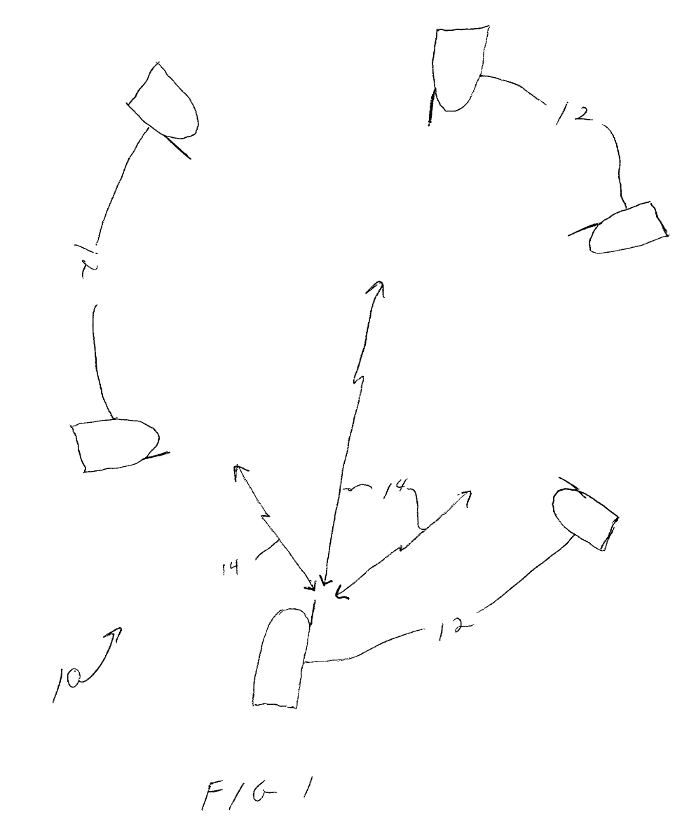

Referring now to the drawings, wherein like reference numerals designate identical or corresponding parts throughout the several views and more particularly to FIG. 1 thereof, wherein a group 10 of individual wireless terminals 12 are shown interacting by way of local radio links 14 used for two-way communication. Although FIG. 1 shows six terminals in the group, in fact any number of terminals can be included from two up to the maximum number, which the protocol is able to handle. In the case of Bluetooth, the maximum number is seven.

Although the preferred protocol is Blue tooth and the preferred communication link is a radio wave link, other protocols and communication links are also possible. Thus, any LPRF (low power radio frequency) point-to-point link or a communication link via WLAN, GSM, or other kinds of networks where members can communicate to each other by point-to-point connections can be used. Thus, infrared or other optical wavelengths could also be used. Other frequencies of radio waves could also be used as well as any other type of wireless communication. Other protocols could also be used in a similar fashion as long as they allow a group of terminals to operate together.

The basic idea is to use the terminal and the applications, which are contained therein together to acquire greater functionality than is possible by one terminal singly. Terminals within the same room or other space typically form the group. However, it is possible that terminals may be part of the group and be removed to a more remote site as long as communication is possible. The terminals communicate directly to each other in a peer-to-peer arrangement. No server is necessary as a connection point between the group members.

A group can be created among the terminals themselves. When the users of the terminals decide to create a new group, one of the terminals starts a procedure by polling the other nearby terminals and receiving responses. The beginning terminal acts as a master and the other terminals act as slave devices If it is decided that a different terminal should be the master, the master situation can be switched at any time. This procedure for starting a group using a master and switching the mastership to a different terminal is well known in the Bluetooth protocol. Once the group is established, it may be used for as long as the group decides. New members be added or dropped as desired. The group may operate even if one of the group members is not available.

Once the group is created, any member of the group will be recognized automatically when the environment is paged automatically. Terminals may be recognized by their identification numbers, which are permanently affixed in their memories. After the terminals have been recognized and acknowledged, the group session may then begin. This session can extend as long as desired until the group decides to end the session. The group may also be reinstated for a later session if desired. Group members may enter into different groups with different terminals for different purposes. A temporary group may also be established for a temporary time. In practice, the group is intended to be a relatively intimate group who can work together and in doing so create a more powerful device than they would have singly. For example, it would be a valuable working tool for small groups to do teamwork.

The basic concept of the terminals in the group is to have a basic function which is operable when not in a group but having additional applications, software or other functionalities which may be shared when a group session is involved. Thus, the terminals may be sold with a certain basic set of functions, applications and software which are usable by themselves and which are identical from unit to unit. However, additional functions, applications or software may be added randomly to the basic set which can then be shared when terminals interact in a group. Thus, when a terminal operates by itself it may only utilize the basic set of functions plus the additional function that it contains itself. However, when operating in a group it has access to not only the basic function and its own additional function, but also the additional functions for other members of the group, which can be shared among them. This could also include versions of data and software resulting them to be shared with the group members.

For example, one facility, which may be used by group members, may involve a program such as a drawing application. The drawing application may be used in an enhanced state where features can be included such as additional activities, tools, drawing objects, etc. Users in a group may be capable of sharing one mutual drawing to be made together with each doing their own editing by using their own terminals. Alternatively, the group members can get additional features of one facility to appear which is usable while the group is active. The enhanced features and drawing facilities may differ from one terminal to another meaning that the terminals of the group may have different software applications of the same software product. It may also happen that one group member has a software facility of his terminal while the others are present and active, even though he does not necessarily do anything other than be present in the group. As additional group members arrive or join the group, more additional features become available to the group as a whole. At some point, the maximum number of features may be reached which may be less than the total number of members in the group. For example, the maximum functions may occur when four or five members are active in the group even though seven members are possible for the total group size. Thus, in a drawing program various feature enhancements may be possible and new image databases or sets of images may become available. Or a totally new feature may be available when enabled or awakened by another terminal when the group reaches a certain size.

Any type of software applications or facilities may become enabled when the group reaches a set size. For example, composing a piece of music may not be done alone and the software may be at least partly available when two or more members are present and in the group. When a third member arrives, polyphony music can be composed. Thus, additional features may be available once a certain group size is reached. Thus, text editing, animation, blinking, etc. may become available when the group is active or when a certain size of the group is reached. The result of these functions can be saved in each terminal. The product of the group, whether music, text, animation, drawing, etc. can be changed when the whole group is present and the group session is active. It can become a private product and can be used without the group being present if the group jointly decides to change it to a private file.

If the terminal of one of the group members is lost, broken or stolen, the rest of the members can still enter into an active group. The person not having a terminal can write in his password or pin number and thus provide proof of his being in the group. The missing terminal can be removed from the group and allow the rest of the terminals to be considered a full group. It may be necessary for the remaining group members to change their passwords or pin numbers. This may be helpful if something happens to one group member when the remaining group members need to continue their work.

Each terminal may have a password, which is conveyed to the other terminals in the group for exceptional situations. Then all the terminals belonging to the group have the passwords of other members as well as their own terminal identifications. If more than one member of the group is absent, the group owned files might not be accessed. The majority of the remaining group members can remove a group member from the group. Thus, files owned by a group can be updated to include information of the group. If files refer to group information outside the file, the group information can be checked from the updated list of members. The group rules may also require that if more than one group member is absent then files owned by the group may not be accessible. If a group member decides to resign from the group, the group members need to agree. Group owned file membership is arranged when the resignation is agreed upon. If more than one group member has left the group without first agreeing, the group owned files are left as such without changing ownership. Thus, various rules of who owns the group files are provided internally so that commonly conceived work cannot be removed by individuals.

Another possibility to handle missing members is to have a clearing-house arrangement so that when the rest of the group is active, the clearing-house server can be contacted to obtain the missing member password. Since a clearinghouse is secure and an authorized party, the answer is trustworthy. After having proved the absence of the missing person, the group might remove him from the group. The trustworthy party may be the mother of a child if the group members are children, the teacher where the group is in a classroom, the head of human resources if the group is a work related group, etc. It is also possible that ciphering keys can be used so that the files are encrypted. This is especially useful if the terminals are involved in business applications and the users are workers of a company.

When the software is produced which will be in the terminals when sold, the various terminal units may include different versions of the same software applications or features. Thus, not all of the terminal buyers get 100% of the same software in their terminals although the application or features are titled the same and are for the same sort of basic useages of the software products of the terminals. When a group meets in some group size, the members receive the missing parts of the software from each other's terminals temporarily. This does not exclude a member from retaining some piece of software permanently for private use as an incentive for joining groups frequently. This could apply especially to users who join multiple groups frequently as recorded by his terminal device. From a business perspective this could apply to software, which are not the latest software version. The owner of a terminal does not know what additional sections it includes until he is a member of a group.

If a game is bought which has been labeled to indicate that it can be enhanced in a group, some parts or additional features of the game will not be available to be seen or used until he has joined a group. Then depending on the original software product optional things are enabled when a user joins a group of a certain size. If others have bought the same game, the game may expand into new levels when the owners belong to some group and are active. The game can also expand to a new layer when in a group one player has certain game software and others are present with their terminals active. The single user can play while others observe his playing from their own terminals. The invention can be applied in a GSM system in which a set of point-to-point connections is handled. For example, in a network environment including a GPRS or 3G-system, the terminals including the subject functioning can be used. While a server and a network can be used as well, the present invention need not have any supporting server for the group management controller activities.

The end result of using the terminals in a group is that users, especially children will enjoy using their devices in new ways in a group, which they cannot do separately. In addition, it allows students or workers to jointly work together on projects. This innovation gives incentive to users to explore what additional functions can be achieved in various groups. Thus, it allows for a social interaction and fun with friends and additional ways of being creative and sharing in groups.

1. A wireless communication system, comprising:
a plurality of wireless terminals, each of said wireless terminals including basic functions which are similar plus additional functions which are individual to each terminal;
said terminals being in wireless communication with each other;
at least some of said wireless terminals forming a group there between, said terminals in said group sharing said additional functions so that the total available functions of the group are greater than the functions of an individual terminal.

2. The system of claim 1, wherein the wireless communication link is a low power radio frequency utilizing the Blue tooth protocol.

3. A system according to claim 1, wherein the additional function of the terminals is an additional software application.

4. The system according to claim 1, wherein the group includes a minimum of two and a maximum of seven terminals.

5. The system according to claim 1, wherein the group is established by one terminal becoming a master, which scans other units in the vicinity which join the group as slaves.

6. A system according to claim 5, wherein terminals in the group may be removed from the group by the remainder of the terminals in the group.

7. The system according to claim 1, wherein another group of additional functions become available to the group only when a certain minimum number of terminals join the group.

8. The system according to claim 1, wherein another group of additional functions become available and which are available for a single terminal after having been a member of the group.

9. A wireless terminal for use in a wireless communication system, comprising:
a transmitter;
a receiver;
a communication device for handling transmitted and received wireless messages;
a basic set of functions which are common to all terminals; and
an additional set of functions which are varied in different terminals.

10. The terminal according to claim 9, wherein the additional set of functions are software applications

11. The terminal according to claim 9, wherein said terminal is in communication with at least one other terminal using wireless communication links.

12. A group of wireless terminals, comprising:
a plurality of individual terminals forming said group;
one of said terminals forming a master terminal which controls interactions between the terminals in the group;
said terminals interacting within said group by wireless communication links;
each of said terminals having a basic set of functions which are similar among the terminals; and
each of said terminals having an additional set of functions which are not common among the terminals.

13. The group of wireless terminals according to claim 12, wherein the wireless communication link is a low power radio frequency utilizing the Blue tooth protocol.

14. The group of wireless terminals according to claim 12, wherein the additional function of the terminals is an additional software application.

15. The group of wireless terminals according to claim 12, wherein the group includes a minimum of two and a maximum of seven terminals.

16. The group of wireless terminals according to claim 12, wherein terminals in the group may be removed from the group by the remainder of the terminals in the group.

17. The group of wireless terminals according to claim 12, wherein another group of additional functions become available to the group only when a certain minimum number of terminals join the group.

18. The group of wireless terminals according to claim 12, wherein another group of additional functions become available and which are available for a single terminal after having been a member of the group.
